(19) United States
(12) Patent Application Publication
(10) Pub. No.: US 2015/0371341 A1
(43) Pub. Date: Dec. 24, 2015

(54) MANAGING SOCIAL FEED ASSIGNMENT

(71) Applicant: ADOBE SYSTEMS INCORPORATED, San Jose, CA (US)

(72) Inventors: Kannan Iyer, San Ramon, CA (US); Pallav Laskar, San Jose, CA (US); Andrew Michael Boylan, Oakland, CA (US)

(21) Appl. No.: 14/310,190

(22) Filed: Jun. 20, 2014

(51) Int. Cl. G06Q 50/00; H04L 12/58

(52) U.S. Cl. CPC G06Q 50/01; H04L 51/32

(57) ABSTRACT

Moderation of social content is facilitated by the generation and assignment of social feeds to moderators. An admin tool may allow an administrator to generate a social feed by defining capture rules to capture social mentions from social networking services. The administrator may also select the social networking services for the social feed. The social feed may be assigned to moderators and/or moderator groups such that the social feed and the social mentions from the social feed appear in the moderation tools of the assigned moderators. The admin tool may also allow the administrator to further manage social feeds by unassigning moderators, modifying social feeds, deleting social feeds, and controlling privileges of moderators for social feeds.

### BACKGROUND

Social networking has become an increasingly popular presence on the Internet. Social network services allow users to easily connect with friends, family members, and other users in order to share, among other things, comments regarding activities, interests, and other thoughts. As social networking has continued to grow, companies have recognized value in the technology. For instance, companies have found that social networking provides a great tool for managing their brand and driving consumers to their own web sites or to otherwise purchase their products or services. Companies can create their own social networking profiles for communicating with consumers via social networking posts and other messages. Additionally, since users often employ social networking to comment on products and services, companies can mine social data to identify what consumers are saying about the company, as well as its products, services, and industry in general. In some cases, companies may even choose to respond to consumers' comments on social networks or take other actions.

### SUMMARY

This summary is provided to introduce a selection of concepts in a simplified form that are further described below in the Detailed Description. This summary is not intended to identify key features or essential features of the claimed subject matter, nor should it be used as an aid in determining the scope of the claimed subject matter.

Embodiments of the present invention relate to managing the assignment of social feeds to moderators who are tasked with moderating social mentions captured from social networking services based on capture rules defined by an administrator. An admin tool allows an administrator to generate a social feed by defining one or more capture rules for capturing social mentions. Additionally, the administrator may set forth one or more social networking services from which the social feed will capture data. The administrator may assign the social feed to any number of individual moderators and/or moderator groups (i.e., a defined set of moderators). The social feed and social mentions from the social feed are provided in the moderation tool of those assigned moderators, allowing the assigned moderators to review and take moderation actions on the social mentions. The admin tool may also allow the administrator to further manage the social feed by unassigning the social feed from previously assigned moderators, modifying the social feed, deleting the social feed, and/or controlling moderator privileges for the social feed.

### BRIEF DESCRIPTION OF THE DRAWINGS

The present invention is described in detail below with reference to the attached drawing figures, wherein:

FIG. 1 is a block diagram showing a system for creating, assigning, and managing social feeds in accordance with an embodiment of the present invention;

FIG. 2 is a flow diagram showing a method for generating and assigning a social feed in accordance with an embodiment of the present invention;

FIG. 3 is a flow diagram showing a method for unassigning a social feed from one or more moderators in accordance with an embodiment of the present invention;

FIG. 4 is a flow diagram showing a method for modifying a social feed in accordance with an embodiment of the present invention;

FIG. 5 is a flow diagram showing a method for deleting a social feed in accordance with an embodiment of the present invention; and

FIG. 6 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

The terms “social networking service” and “social networking site” refer to any online presence at which a user may share comments with other users within a social network. For instance, this may include services, such as the TWITTER, FACEBOOK, LINKEDIN, TUMBLR, and YOUTUBE services, to name a few.

A “capture rule” refers to criteria, such as text, phrases, and/or metadata, used to capture social data from social networking services that is provided to and/or displayed within a moderation tool as social mentions.

A “social mention” includes any social networking message that matches the criteria set forth by one or more capture rules. A social mention may include both the content of a social networking message (e.g., text, images, videos, links, etc.) and metadata associated with the message.

A “moderation tool” refers to a component of a social analysis tool that receives social mentions captured using a capture rule and allows a moderator to review the social mentions and take moderation actions on the social mentions.

A “moderation action” refers to any action that may be taken for a social mention. This may include, for instance, responding to a social message (e.g., responding to a tweet from a consumer using the TWITTER service), resending a social message (e.g., retweeting a tweet), liking a social message, or reporting an author who repeatedly posts bad content as a spammer. In some instances, a moderation action may be an action internal to a company, such as flagging a social mention for escalation or review by another moderator within the company.

A “moderator” is a person who is responsible for reviewing social mentions for a company and deciding whether to take moderation actions on certain social mentions.

A “moderator group” is a defined set of moderators.

A “social feed” refers to a defined set of one or more captures rules to capture social mentions from one or more identified social networking services. By way of example to illustrate, a social feed could include the following rules: reach>10000 AND sentiment<3 AND (HASHTAG=BRAND1 OR BRAND2) AND provider=TWITTER. As another example, a social feed could include the following rules: TWITTER_account=my_brand AND emotion=frustration AND reach>10 K. As a further example, a social feed could include the following rules: FACEBOOK_page=page1 OR FACEBOOK_page=page2 AND campaign=THANKSGIVING.

An “admin tool” refers to a component of a social analysis tool that allows an administrator to create, assign, unassign, modify, delete, and/or otherwise manage social feeds.

An “administrator” refers to a person who has rights to create, assign, unassign, modify, delete, and/or otherwise manage social feeds using an admin tool. In some instances, a moderator who has such rights may be considered an administrator.

To assist companies in their social networking efforts, some social analysis tools, such as the ADOBE SOCIAL tool, have been developed that provide mechanisms for companies to collect information regarding what consumers are saying and manage responses to consumers' social networking messages. These social analysis tools allow companies to set rules for capturing social data from social networks. The captured social data may be provided by a social analysis tool as a list of social mentions that each may include the content of a social networking message and metadata associated with the message. A person (i.e., a moderator) may review each social mention and determine to take moderation actions on some of the social mentions, such as posting responses to the social networking messages. Often, a large number of social mentions are captured, creating a large amount of data for moderators to sift through to find social mentions to take moderation actions on. Managing this large amount of data has proven difficult.

Embodiments of the present invention allow, among other things, an administrator to efficiently manage moderation of social data by defining social feeds and selectively assigning each social feed to any number of moderators. An admin tool allows an administrator to create a social feed by defining one or more capture rules for capturing social mentions from any number of identified social networking services. The administrator may assign the social feed to individual moderators and/or moderator groups. This allows the administrator to delegate social content to specific moderators who can handle the social content more efficiently. When moderators log into their moderation tool, they can automatically see any assigned social feeds, view the social mentions captured by assigned social feeds, and perform various moderation actions.

The admin tool may provide a number of additional functions that allow an administrator to manage social feeds. An administrator may make social feed assignment modifications by assigning the social feed to additional moderators and/or unassigning the social feed from previously assigned moderators. The administrator may also employ the admin tool to modify or delete a social feed after its initial creation. A social feed may be modified by adding new capture rules, deleting existing capture rules, and/or modifying existing capture rules. If a social feed is modified, the modifications are pushed to the moderation tool for each assigned moderator, and the feed contents from the social feed reflect the change. If a social feed is deleted, the social feed is removed from the moderation tool for each assigned moderator.

The admin tool may further allow the administrator to control various privileges for moderators. For instance, the administrator may control privileges that allow moderators to modify and/or delete social feeds. In some instances, an assigned social feed is read-only to assigned moderators to prevent the moderators from changing any capture rules or assignments. However, the administrator may allow a select list of moderators to change the capture rules in which case, the changes remain local to the moderator who changed it. The administrator may allow assigned moderators to clone the assigned social feed. This would create a social feed just as the assigned social feed but remains local to the moderator. Any changes to the cloned social feed by the moderator would not affect other assigned moderators and just remains local to the moderator who has cloned the social feed. The administrator may also control which types of moderation actions can be performed on social mentions by each assigned moderator. For example, moderator A may be given permissions to flag, retweet, spam, and escalate social mentions, while moderator B may be given permissions to just flag and escalate social mentions. The administrator may further control the ability for assigned moderators to share social feeds with other moderators.

Accordingly, in one aspect, an embodiment of the present invention is directed to a non-transitory computer storage medium comprising computer-useable instructions that, when used by one or more computing devices, cause the one or more computing devices to perform operations. The operations include generating a social feed to capture, from one or more social networking services, social mentions that satisfy one or more capture rules defined by an administrator. The operations also include assigning the social feed to one or more moderators. The operations further include providing the social feed to a moderation tool for each of the one or more moderators that allows each of the one or more moderators to view the social mentions and perform moderation actions for at least a portion of the social mentions.

In another embodiment of the invention, an aspect is directed to a computer-implemented method. The method includes assigning, via a first computing process, a social feed to one or more moderators, the social feed including one or more capture rules defined by an administrator to capture social mentions from one or more social networking services. The method also includes providing, via a second computing process, the social feed to a moderation tool for each of the one or more moderators that allows each of the one or more moderators to view social mentions captured by the social feed and perform moderation actions for at least a portion of the social mentions. The method further includes receiving, via a third computing process, a modification to the one or more capture rules of the social feed. The method still further includes providing, via a fourth computing process, the modification to the moderation tool for each of the one or more moderators. The first, second, third, and fourth computing processes are performed by one or more computing devices.

A further embodiment is directed to a computerized system comprising: one or more processors; and one or more computer storage media storing a plurality of modules comprising computer-useable instructions that, when used by the one or more processors, cause the one or more processors to perform operations. The modules include a social feed generation module for generating a social feed that includes one or more capture rules defined by an administrator, the one or more capture rules including criteria for capturing social mentions from one or more social networking services. The modules also include a moderator assignment module for assigning the social feed to one or more moderators.

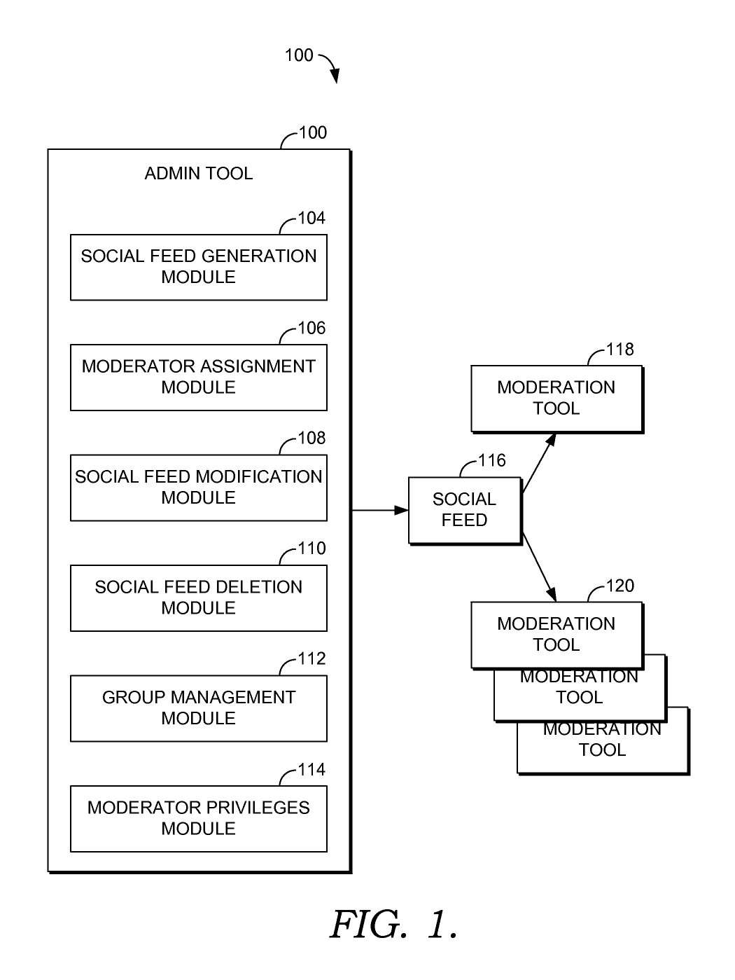

Turning now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

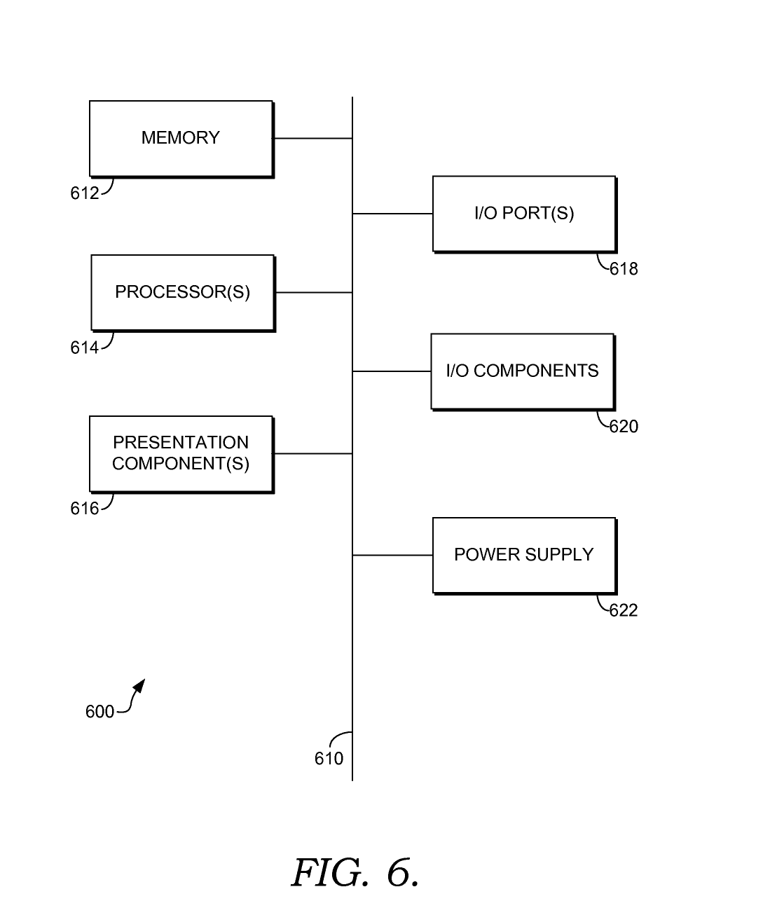

The system in FIG. 1 includes an admin tool 102 that allows, among other things, an administrator to create social feeds, such as the social feed 116, and assign the social feeds to moderators and/or moderator groups. When a social feed is assigned to an individual moderator, the social feed appears in that moderator's moderation tool, such as the moderation tool 118. When a social feed is assigned to a moderator group, the social feed appears in the moderation tool for each moderator belonging to the moderator group, such as the moderation tools for the moderation group 120. The admin tool 102 and each of the moderation tools 118, 120 may be implemented via any type of computing device, such as computing device 600 described below with reference to FIG. 6, for example. Each may be implemented on a single device or multiple devices cooperating in a distributed environment.

As shown in FIG. 1, the admin tool 102 includes, among other things, a social feed generation module 104, a moderator assignment module 106, a social feed modification module 108, a social feed deletion module 110, a group management module 112, and a moderator privileges module 114.

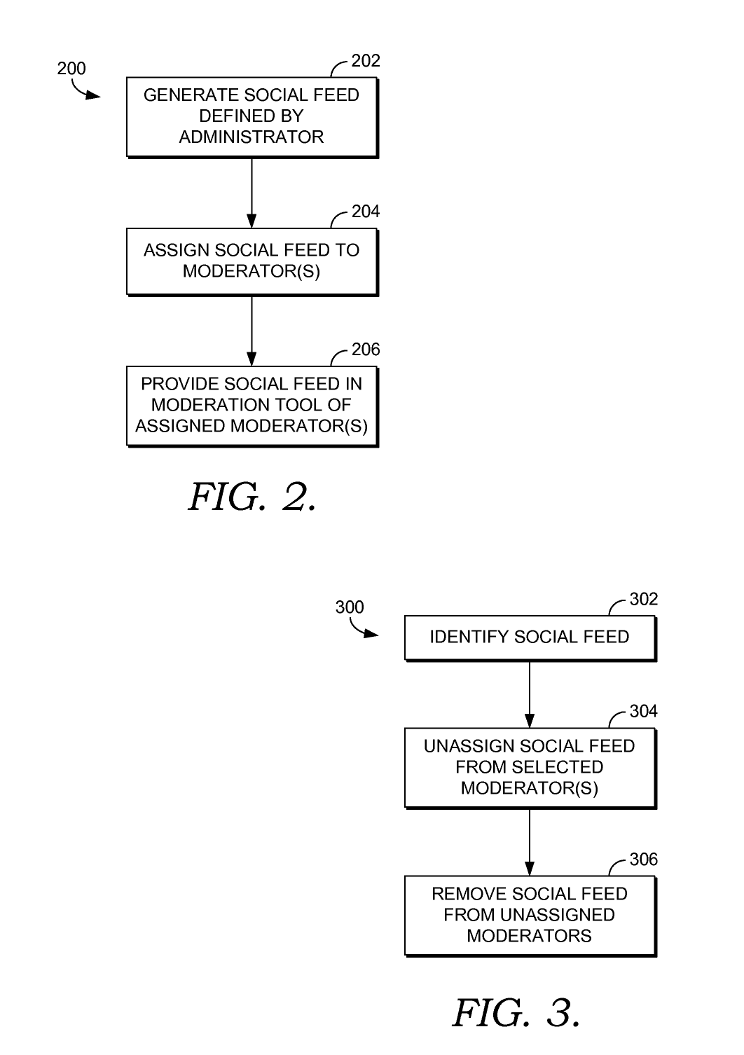

The social feed generation module 104 allows an administrator to generate social feeds by defining criteria of the social feeds. Social feeds created using the social feed generation module 104 may be assigned to moderators using the moderator assignment module 106. FIG. 2 provides a flow diagram showing a method 200 for generating and assigning a social feed that may be performed by the social feed generation module 104 and the moderator assignment module 106. Each block of the method 200 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. For example, the methods may be provided as part of a social analysis tool, such as the ADOBE SOCIAL tool.

Initially, as shown at block 202, a social feed is generated based on criteria specified by an administrator. For instance, a user interface may be provided that allows the administrator to identify one or more social networking services. These social networking services may include, for instance, the TWITTER, FACEBOOK, LINKEDIN, TUMBLR, and YOUTUBE services, to name a few. In some instances, the administrator may generate a social feed that is directed to capturing social messages from a single social networking service. In other instances, the administrator may generate a social feed that captures social messages from multiple social networking services. In further embodiments, the admin tool 102 may be configured to automatically capture social messages from one or more social networking services such that the administrator does not need to specify the social networking services for the social feed.

The administrator may also use the user interface to define one or more capture rules for the social feed. The capture rules include criteria, such as text, phrases, and/or metadata, used to capture social data from the social networking service(s). For instance, a capture rule may be defined to capture social messages that contain certain keywords. As another example, a capture rule may be defined to capture messages that are analyzed as containing a particular sentiment or emotion. As a further example, a capture rule may be defined to capture social messages with particular metadata, such as the author being located with a defined geographical region.

In some embodiments, the social feed may be named and saved. Naming and saving social feeds allows the administrator to manage the various social feeds (e.g., assigning to moderators, modifying, deleting, etc.). In some instances, the admin tool 102 may automatically name the social feed. In other instances, the administrator may manually name the social feed. For instance, the administrator may use a naming strategy that allows the administrator to quickly identify what each social feed is directed to capturing.

The social feed is assigned to one or more moderators, as shown at block 204. Social feeds may be assigned to moderators in a number of different manners in accordance with various embodiments of the present invention. In some instances, one or more moderators may be individually selected for a social feed. For example, a user interface may be provided that allows the administrator to individually select moderators. The social feed is then assigned to each selected moderator. In other instances, an administrator may assign a social feed to a moderator group, which is a defined set of moderators. For example, a user interface may be provided that allows the administrator to select a moderator group. By using a moderator group, the administrator does not need to individually select each moderator in the group but may instead just select the moderator group.

In some embodiments, social feeds may be automatically assigned to particular moderators and/or moderator groups based on the social networking services and/or capture rules defined for the social feeds. For example, all social feeds that are directed to capture social content from the TWITTER service may automatically be assigned to a moderator or moderator group that specializes in moderating messages from the TWITTER service. As another example, all social feeds with a particular sentiment or emotion may be assigned to a particular moderator or moderator group (e.g., all frustrated social feeds go to Duffy; all angry social feeds go to Jimmy; etc.). The administrator may initially create auto-assign rules to automatically assign certain types of social feeds to certain moderators/moderator groups and the auto-assign rules may then be employed to automatically assign social feeds to moderators/moderator groups.

As shown at block 206, the social feed is provided in the moderation tool of each of the one or more moderators identified at block 204. If the social feed is assigned to any individual moderators at block 204, the social feed and social mentions from the social feed appear in the moderation tool for each of those assigned moderators. If the social feed is assigned to a moderator group at block 204, the social feed and social mentions from the social feed appear in the moderation tool for each moderator belonging to the moderator group. As such, the assigned moderators can efficiently moderate the social mentions from the social feed.

After a social feed is initially generated and assigned, the moderator assignment module 106 may allow an administrator to later assign the social feed to additional moderators. For instance, a user interface may be provided that allows the administrator to select from a social feed from a list of existing social feeds. The administrator may then add individual moderator(s) and/or moderator group(s).

The moderator assignment module 106 may also be used by an administrator to unassign the social feed from assigned moderators. FIG. 3 illustrates a flow diagram showing a method 300 for unassigning a social feed from one or more moderators that may be employed by the moderator assignment module 106. As shown at block 302, a social feed is identified. For instance, a user interface may be provided that allows the administrator to select from a list of existing social feeds. The social feed is unassigned from one or more moderators to which the social feed was previously assigned, as shown at block 304. For instance, a user interface may be provided that lists individual moderators and/or moderator groups to which the social feed has been assigned. The administrator may select moderator(s) and/or moderator group(s) from that list to unassign the social feed from the selected moderator(s)/moderator group(s). The social feed is removed from the moderation tool of the unassigned moderators, as shown at block 306. As such, the social feed and social mentions from the social feed will no longer appear in the moderation tool of the unassigned moderators.

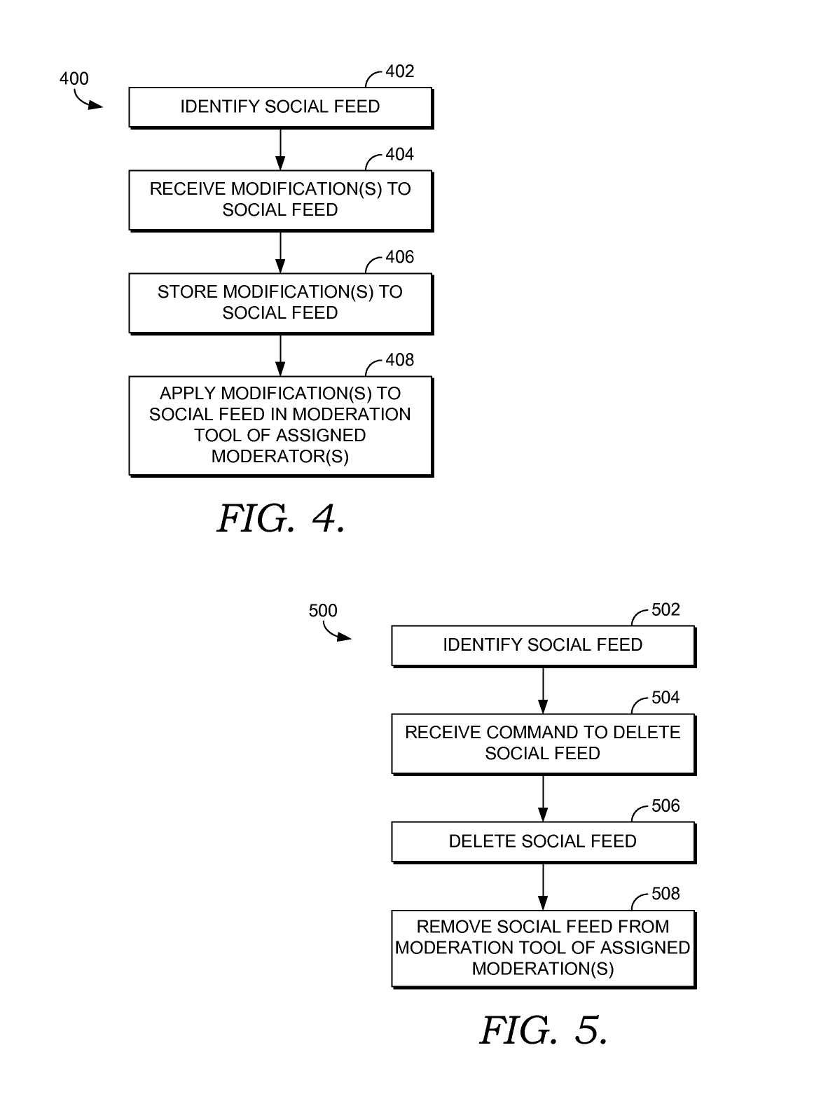

Turning back to FIG. 1, the admin tool 102 also includes a social feed modification module 108 that allows the administrator to modify a social feed. FIG. 4 provides a flow diagram showing a method 400 for modifying a social feed that may be performed by the social feed modification module 108. As shown at block 402, a social feed is identified. For instance, a user interface may be provided that allows the administrator to select from a list of existing social feeds. One or more modifications to the selected social feed are received, at block 404. For instance, a user interface may be provided that allows the administrator to remove an existing social networking service, add a new social networking service, change or remove an existing capture rule, and/or add a new capture rule to the social feed.

The modifications to the social feed are stored, as shown at block 406. Additionally, the modifications are applied to the social feeds in the moderation tools of the moderators to which the social feed has been assigned, as shown at block 408. As such, the social feed and the social mentions from the social feed provided in the moderation tool of assigned moderators will reflect the modifications.

The admin tool 102 also includes a social feed deletion module 110 that may be employed by an administrator to delete a previously created social feed. FIG. 5 illustrates a flow diagram showing a method 500 for deleting a social feed that may be employed by the social feed deletion module 110. As shown at block 502, a social feed is identified. For instance, a user interface may be provided that allows the administrator to select from a list of existing social feeds. A command to delete the social feed is received, as shown at block 504. The social feed is deleted in response to the command, as shown at block 506. The social feed is also removed from the moderation tools of the moderators to which the social feed was assigned, as shown at block 508. As such, the social feed and social mentions from the social feed will no longer appear in the moderation tools of the moderators.

With reference to FIG. 1 again, the admin tool 102 also includes a group management module 112 that allows an administrator to manage moderator groups. For instance, a user interface may be provided that allows an administrator to create moderator groups and assign moderators to the each moderator group. The administrator may also be able modify moderator assignments to moderator groups (e.g., by adding or removing moderators) and may also be able to delete moderator groups.

The admin tool 102 further includes a moderator privileges module 114 that allows an administrator to control various privileges of moderators. In some embodiments, the administrator may employ the moderator privileges module 114 to control the types of moderation actions that each assigned moderator may be able to perform on social mentions from a social feed. As previously discussed, a moderation tool may generally allow for a number of different types of moderation actions to be taken on social mentions. These different types of moderation actions may include, for instance, responding to social messages, resending social messages, liking social messages, and reporting an author as a spammer, to name a few. The administrator may control which moderation actions can be performed by each moderator or moderator group to which a social feed has been assigned. The administrator may indicate which moderation actions may be performed and/or which moderation actions cannot be performed by each assigned moderator/moderator group. For instance, an administrator may assign a social feed to two moderators. The administrator may then set the moderation action privileges of the two moderators to task the first moderator with responding to social messages and task the second moderator with reporting spammers.

In some embodiments, social feeds generated by an administrator may not be modified or deleted by moderators. This allows the administrator to have sole control of managing the social feeds. In other embodiments, the administrator may control modification and/or deletion privileges of moderators. In particular, the administrator may grant selected moderators and/or moderator groups the right to modify and/or delete social feeds. In some instances, such modifications or deletions may only affect the social feed in the moderation tool of the moderator or moderator group who made the changes. In other instances, such modifications or deletions may be pushed out to the moderation tool of all assigned moderators.

The moderator privileges module 114 may further allow an administrator to control sharing privileges of moderators. In particular, some embodiments allow assigned moderators to share social feeds with other unassigned moderators. Sharing may include reassigning the social feed to another moderator. For instance, a first moderator may have too many tasks to complete and may wish to have a second moderator review social mentions from a social feed assigned to the first moderator but not assigned to the second moderator. The first moderator could share the social feed with the second moderator, allowing the second moderator to view the social feed and associated social mentions in the second moderator's moderation tool. Using the moderator privileges module 114, the administrator may control whether each assigned moderator or moderator group has the ability to share a social feed with an unassigned moderator or moderator group.

Having described embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present invention provide for the generation of social feeds and assignment of the social feeds to moderators and moderator groups. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A non-transitory computer storage medium storing computer-useable instructions that, when used by one or more computing devices, cause the one or more computing devices to perform operations comprising:
generating a social feed to capture, from one or more social networking services, social mentions that satisfy one or more capture rules defined by an administrator;
assigning the social feed to one or more moderators; and
providing the social feed to a moderation tool for each of the one or more moderators that allows each of the one or more moderators to view the social mentions and perform moderation actions for at least a portion of the social mentions.

2. The non-transitory computer storage medium of claim 1, wherein the one or more social networking services for the social feed are selected by the administrator.

3. The non-transitory computer storage medium of claim 1, wherein generating the social feed includes naming the social feed.

4. The non-transitory computer storage medium of claim 1, wherein assigning the social feed to the one or more moderators comprises:
receiving, from the administrator, an individual identification of each of the one or more moderators.

5. The non-transitory computer storage medium of claim 1, wherein assigning the social feed to the one or more moderators comprises:
receiving, from the administrator, an identification of a moderator group that includes the one or more moderators.

6. The non-transitory computer storage medium of claim 1, wherein the social feed is automatically assigned to the one or more moderators based on the one or more social networking services and/or the one or more capture rules.

7. The non-transitory computer storage medium of claim 1, wherein the operations further comprise:
receiving a command to unassign a first moderator from the one or more moderators; and
removing the social feed from a moderation tool for the first moderator.

8. The non-transitory computer storage medium of claim 1, wherein the operations further comprise:
receiving one or more modifications to the social feed; and
applying the one or more modification to the social feed in the moderation tool for each of the one or more moderators.

9. The non-transitory computer storage medium of claim 7, wherein the one or more modifications comprise modifications to the one or more capture rules.

10. The non-transitory computer storage medium of claim 1, wherein the operations further comprise:
receiving a command to delete the social feed; and
removing the social feed from the moderation tool for each of the one or more moderators.

11. The non-transitory computer storage medium of claim 1, wherein the operations further comprise:
receiving one or more moderator privileges commands to control privileges of at least one of the one or more moderators, the privileges including the ability to perform at least one selected from the following: perform moderation actions for the social mentions from the social feed, modify the social feed, delete the social feed, and share the social feed.

12. A computer-implemented method comprising:
assigning, via a first computing process, a social feed to one or more moderators, the social feed including one or more capture rules defined by an administrator to capture social mentions from one or more social networking services;
providing, via a second computing process, the social feed to a moderation tool for each of the one or more moderators that allows each of the one or more moderators to view social mentions captured by the social feed and perform moderation actions for at least a portion of the social mentions;
receiving, via a third computing process, a modification to the one or more capture rules of the social feed; and
providing, via a fourth computing process, the modification to the moderation tool for each of the one or more moderators;
wherein the first, second, third, and fourth computing processes are performed by one or more computing devices.

13. A computerized system comprising:
one or more processors; and
one or more computer storage media storing a plurality of modules comprising computer-useable instructions that, when used by the one or more processors, cause the one or more processors to perform operations, the modules comprising:
a social feed generation module for generating a social feed that includes one or more capture rules defined by an administrator, the one or more capture rules including criteria for capturing social mentions from one or more social networking services; and
a moderator assignment module for assigning the social feed to one or more moderators.

14. The computerized system of claim 13, wherein the moderator assignment module provides for assigning the social feed to one or more individual moderators.

15. The computerized system of claim 13, wherein the moderator assignment module provides for assigning the social feed to a moderator group comprising a defined set of moderators.

16. The computerized system of claim 15, wherein the modules further comprise:
a group management module for managing the defined set of moderators

17. The computerized system of claim 13, wherein the moderator assignment module further provides for unassigning the social feed from at least one of the one or more moderators.

18. The computerized system of claim 13, wherein the modules further comprise:
a social feed modification module for modifying the social feed.

19. The computerized system of claim 13, wherein the modules further comprise:
a social feed deletion module for deleting the social feed.

20. The computerized system of claim 13, wherein the modules further comprise:
a moderator privileges module for controlling moderator privileges to perform moderation actions for the social mentions from the social feed, modify the social feed, delete the social feed, and/or share the social feed.
